(19) United States
(12) Patent Application Publication
(10) Pub. No.: US 2026/0017944 A1
(43) Pub. Date: Jan. 15, 2026

(54) Method for monitoring and early warning of wild plant distribution status based on image recognition

(71) Applicant: Institute of Vegetables and Flower, Chinses Academy of Agricultural Sciences, Beijing (CN)

(72) Inventors: Haiping WANG, Beijing (CN); Jiangping SONG, Beijing (CN); Xiaohui ZHANG, Beijing (CN); Wenlong YANG, Beijing (CN); Huixia JIA, Beijing (CN)

(73) Assignee: Institute of Vegetables and Flower, Chinses Academy of Agricultural Sciences, Beijing (CN)

(21) Appl. No.: 19/235,446

(22) Filed: Jun. 11, 2025

(30) Foreign Application Priority Data
Jun. 11, 2024 (CN) 202410742474.7

(51) Int. Cl. G06V 20/10; G06T 5/80; G06T 17/05; G06T 19/00; G06V 10/10; G06V 10/143; G06V 10/82; G06V 20/13; G06V 20/17; G06V 20/70

(52) U.S. Cl. CPC G06V 20/188; G06T 5/80; G06T 17/05; G06T 19/00; G06V 10/143; G06V 10/16; G06V 10/82; G06V 20/13; G06V 20/17; G06V 20/70; G06T 2207/10036; G06T 2207/20084; G06T 2207/30188

(57) ABSTRACT

The present invention discloses a method for monitoring and early warning of wild plant distribution status based on image recognition, relating to the technical field of monitoring and early warning of wild plant distribution status. This method promotes the scientific assessment of ecological protection status of each sub-area by calculating coverage indexes Fgl and population complexity indexes When one of the coverage indexes or the population complexity indexes of a sub-area does not reach a preset threshold, an unqualified mark is marked accordingly. By calculating environmental pressure indexes HJyl, a first early warning instruction is automatically sent when one of the environmental pressure indexes HJyl exceeds a preset first pressure threshold, indicating that the environmental pollution status is unqualified.

### CROSS-REFERENCE

This application claims the benefit of priority from China Patent Application No. CN202410742474.7 filed on Jun. 11 2024, the contents of which are hereby incorporated by reference in their entirety.

### TECHNICAL FIELD

The present invention relates to the technical field of monitoring and early warning of the distribution status of wild plants, and in particular to a method for monitoring and early warning of wild plant distribution status based on image recognition.

### BACKGROUND TECHNOLOGY

With the continuous intensification of global climate change and human activities, the living environment of wild plants has deteriorated day by day, and the survival status of endangered plants has become more worrying. Endangered plants are not only an important part of the ecosystem, but also have high scientific research and protection value. Traditional endangered plant monitoring methods mainly rely on manual surveys and fixed-point observations. These methods are inefficient and easy to miss important information when facing the vast natural environment and diverse plant populations.

The distribution and coverage of endangered plants are important indicators for assessing the health of ecosystems. Areas with high coverage usually have higher conservation value. Classifying and maintaining these areas can effectively protect the living environment of endangered plants and prevent them from further reduction or extinction. However, existing technologies have great limitations in identifying and analyzing the distribution of endangered plants, and cannot provide accurate coverage data in a timely manner, thus affecting the implementation of conservation measures.

### SUMMARY OF THE INVENTION

### I. Technical Issues to be Resolved

In view of shortcomings of the prior art, the present invention provides a method for monitoring and early warning of wild plant distribution status based on image recognition to solve the problems mentioned in the background technology.

### II. Technical Solutions

To achieve the above objectives, the present invention is implemented through following technical solutions: a method for monitoring and early warning of wild plant distribution status based on image recognition, comprising following steps of:
using GIS (Geographic Information System) technology and remote sensing data, according to geographic features and ecological environment information, establishing a three-dimensional ecological model, dividing an area being monitored into sub-areas, and setting up corresponding data collection points within the sub-areas, wherein the sub-areas are divided according to ecosystem types, including forests, grasslands, and wetlands;
using multi-rotor drones equipped with multispectral satellite imaging devices to collect plant distribution images in the sub-areas, and establishing image datasets;
utilizing convolutional neural network (CNN) models or deep learning model techniques to establish plant recognition models, analyzing the image datasets to identify species and coverage of endangered plants, and calculating distribution and coverage of endangered plants in the sub-areas to obtain coverage indexes Fgl and population complexity indexes fz, wherein
when a coverage index Fgl of a sub-area exceeds a preset protection threshold, it indicates that the sub-area meets ecological protection standards, and a first qualified mark is labeled in the three-dimensional ecological model;
when a population complexity index fz of a sub-area exceeds a preset second ecological stability threshold, it indicates that a diversified population structure within the sub-area is qualified, and a second qualified mark is applied in the three-dimensional ecological model;
setting up environmental monitoring points in sub-areas that have received both the first and second qualified marks, so as to collect environmental information and pollution information from the sub-areas and establish first ecological environment datasets; constructing environmental pressure indexes HJyl according to the first ecological environment datasets, wherein if an environmental pressure index HJyl exceeds a first pressure threshold, a first early warning instruction is sent externally;
setting up second monitoring points in sub-areas that have received both the first and second qualified marks, so as to collect information and quantity data of harmful plants and establish second invasive alien species datasets; constructing invasive species disturbance indexes Rqgr according to the second invasive alien species datasets, wherein if an invasive species disturbance index Rqgr exceeds a safety threshold, a second early warning instruction is sent externally, and corresponding repair strategies is generated based on a first early warning instruction and a second early warning instruction.

Preferably, the geographical features and ecological environment are obtained by using GIS technology and remote sensing data, high-resolution satellite imagery and drone aerial photography in the area being monitored, which comprise topography, vegetation coverage, and hydrological characteristics; the three-dimensional ecological model is established according to obtained geographic and ecological data of the area being monitored, and the three-dimensional ecological model comprises following components: terrain elevation data DEM, vegetation type layers and hydrological layers; the vegetation type layers show spatial distribution of different vegetation types, and the hydrological layers show location and characteristics of rivers, lakes and wetlands; and
according to the three-dimensional ecological model, the area be monitored is divided into sub-areas, and collection points are established in the sub-areas.

Preferably, the image datasets obtained by drones are spliced into a complete image covering the sub-areas, the plant recognition models are established after performing geometric correction and spectral correction on the image datasets, and image recognition tasks are processed through convolutional neural networks (CNN), endangered plant species, non-endangered plant species, harmful plant species, plant health status, vegetation type characteristics and coverage area characteristics in the sub-areas, are extracted, and the image datasets are labeled to mark out category and location information of each plant; and the image datasets are used as first input into the plant recognition models to calculate the coverage indexes Fgl and the population complexity indexes fz, wherein
the coverage indexes Fgl are generated by following formulas:

$${CR}_{i} = \frac{{A}_{i}}{{A}_{total}} ,$$

$$H = - {\sum }_{i = 1}^{n} ( \frac{{A}_{i}}{{A}_{total}} * ln ( \frac{{A}_{i}}{{A}_{total}} ) ) , and$$

$$Fgl = {\sum }_{i = 1}^{n} ( {w}_{i} * {CR}_{i} ) * H ,$$

where CRᵢ represents a population proportion of i-th endangered plant species, Aₜₒₜₐₗ represents a total area of the sub-areas, Aᵢ represents a coverage area of the i-th endangered plant species, Wᵢ represents weight of the i-th endangered plant species, based on degree of endangerment and ecological importance, n represents species number of the endangered plants in the sub-areas, H represents uniformity index of plant coverage, calculated by Shannon index, and ln represents logarithmic operation; and
when a coverage index Fgl of a sub-area exceeds a preset protection threshold, it means that the sub-area meets ecological protection standards and the first qualified mark is labeled in the three-dimensional ecological model; and when a coverage index Fgl of a sub-area does not exceed the preset protection threshold, it means that the coverage of the sub-area is unqualified and a first unqualified mark is labeled.

Preferably, the population complexity indexes fz are generated as follows:

$${P}_{i} = \frac{{N}_{i}}{{\sum }_{i = 1}^{n} {N}_{i}} ,$$

$$M = - {\sum }_{i = 1}^{n} {w}_{i} * {P}_{i}^{1 - q} and$$

$$fz = M * \frac{n}{{N}_{total}} ,$$

where Nₜₒₜₐₗ represents total number of all plant species within the sub-areas, Nᵢ represents number of individuals of the i-th endangered plants species, Wᵢ represents weight of the i-th endangered plant species, based on degree of endangerment and ecological importance; n represents species number of the endangered plants in the sub-areas, Pᵢ represents a relative proportion of the i-th endangered plant species, namely, a ratio of a number of individuals to a total number, q represents an adjustment parameter, ranging from 0 to 2, when q=1, value of M equals to weighted sum of different population proportions, when q≠1, and value of M reflects distribution difference of population proportions; and when a population complexity index fz of a sub-area exceeds a preset second ecological stability threshold, it means that a diversified population structure in the sub-area is qualified, and a second qualified mark is labeled in the three-dimensional ecological model; when a population complexity index fz of a sub-area does not exceed the preset second ecological stability threshold, it means that the diversified population structure in the sub-area is unqualified, and a second unqualified mark is labeled.

Preferably, the environmental monitoring points are set up in sub-areas that obtain the first qualified marks and the second qualified marks at the same time, so as to collect environmental information and pollution information in the sub-areas and establish first ecological environment datasets; the environmental information includes but is not limited to following data: average daily air temperature wd, average daily rainfall jyl and average daily sunshine pjgz for 7-15 days obtained meteorological sensors; and longitude and latitude coordinates of industrial processing plants and the sub-areas and distance values jlz between the industrial processing plants near the sub-areas obtained by GPS receivers;
the pollution information includes but is not limited to following data: soil moisture content hs1, soil pH ph1, soil heavy metal and organic matter total content hlz1 water body pH ph2, water body heavy metal and organic matter total content hlz2,atmospheric PM2.5 concentration value pm1, sulfur dioxide concentration value SO₂ in air and nitrogen monoxide concentration value CO in air;
the soil moisture content hs1 is collected and obtained through humidity sensors;
the soil pH ph1 is measured and obtained through soil pH sensors;
the soil heavy metal and organic matter total content hlz1 is obtained through chemical analysis of soil samples;
the water body pH ph2 is measured and obtained through water quality pH sensors;
the water body heavy metal and organic matter total content hlz2 is obtained through chemical analysis of water samples;
the atmospheric PM2.5 concentration value pm1 is measured and obtained through atmospheric particle sensors;
the sulfur dioxide concentration value SO₂ in air and the nitrogen monoxide concentration value CO in air are measured and obtained through air quality sensors.

Preferably, dimensionless processing is conducted on the pollution information, and soil pollution indexes trwr, water pollution indexes swr and air pollution indexes kqwr are obtained by as following formulas:

$$trwr = \sqrt{w 1 * {( \begin{matrix}hs l \\ \overline{\overline{hsl}}\end{matrix} )}^{2} + w 2 * {( \begin{matrix}p h 1 \\ \overline{\overline{p h 1}}\end{matrix} )}^{2} + w 3 * {( \begin{matrix}hlz 1 \\ \overline{\overline{hlz 1}}\end{matrix} )}^{2} + {A}_{1}} ,$$

$$swr = \sqrt{w 4 * {( \begin{matrix}hlz 2 \\ \overline{\overline{hlz 2}}\end{matrix} )}^{2} + w 5 * {( \begin{matrix}p h 2 \\ \overline{\overline{p h 2}}\end{matrix} )}^{2} + {A}_{2}} , and$$

$$kqwr = \sqrt{w 6 * {( \begin{matrix}pm 1 \\ \overline{\overline{pm 1}}\end{matrix} )}^{2} + w 7 * {( \begin{matrix}{SO}_{2} \\ \overline{\overline{{SO}_{2}}}\end{matrix} )}^{2} + w 8 * {( \begin{matrix}CO \\ \overline{\overline{CO}}\end{matrix} )}^{2} + {A}_{3}} ,$$

where h̅s̅1̅ represents a preset threshold of the soil moisture content, p̅h̅1̅ represents a preset threshold of the soil pH, h̅l̅z̅1̅: represents a preset maximum tolerance threshold of the soil heavy metal and total organic matter content, h̅l̅z̅2̅ represents a preset maximum tolerance threshold of the water body heavy metal and total organic matter content, p̅h̅2̅ represents a preset threshold of the water body pH, p̅m̅1̅ represents a preset threshold of the atmospheric pm2.5 concentration, S̅O̅₂̅ represents a preset maximum tolerance threshold of the sulfur dioxide concentration in air, C̅O̅: represents a preset maximum tolerance threshold of the nitric oxide concentration in air, w1, w2, w3, w4, w5, w6, w7 and w8 represent weight values, and specific values thereof are adjusted and set by users, and 0<w1<1, 0<w2<1, 0<w3<1, 0<w4<1, 0<w5<1, 0<w6<1, 0<w7<1, 0<w8<1, w1+w2+w3=1, w4+w5=1, w6+w7+w8=1, A₁ represents a first constant correction coefficient, A₂ represents a second constant correction coefficient, and A₃ represents a third constant correction coefficient; and
then the soil pollution indexes trwr, the water pollution indexes swr and the air pollution indexes kqwr are combined to generate the pollution pressure indexes wryl through following correlation formula:

$$wry l = γ * trwr + δ * swr + α * kqwr ,$$

where, 0≤γ≤1, 0≤δ≤1, and γ+δ+α=1, γ, δ and α are weight values of the soil pollution indexes trwr, water pollution indexes swr and the air pollution indexes kqwr, which are adjusted and set by users.

Preferably, daily average air temperature wd, daily average rainfall jyl, daily average sunshine time pjgz, distance values between industrial processing plants near the sub-areas jlz and pollution pressure indexes wryl are extracted from the first ecological environment datasets and dimensionless processed, and the environmental pressure indexes HJyl are calculated by following formula:

$$HJy l = d 1 * \begin{matrix}wd \\ \overline{\overline{wd}}\end{matrix} + d 2 * \begin{matrix}jyl \\ \overline{\overline{jyl}}\end{matrix} + d 3 * \begin{matrix}pjgz \\ \overline{\overline{pjgz}}\end{matrix} + d 4 * \frac{jlz * wryl}{ln 2} + {A}_{4} ,$$

where w̅d̅ represents a preset air temperature mean threshold, j̅y̅l̅ represents the preset rainfall mean threshold, p̅j̅g̅z̅: represents the preset daily average light exposure time threshold, ln2 represents the logarithmic operation with the natural number 2 as the base, d1, d2, d3 and d4 represent weight values, and 0<d1<1, 0<d2<1, 0<d3<1, 0<d4<1, and d1+d2+d3+r4=1.0; A₄ represents the fourth constant correction coefficient; If an environmental pressure index HJyl is higher than the first pressure threshold, it indicates that environmental pollution is in an unqualified state, and the first early warning instruction is sent externally; and when an environmental pressure index HJyl is less than or equal to the first pressure threshold, it indicates that environmental pressure is qualified.

Preferably, according to the first early warning instruction, a first restoration strategy is generated: vegetation restoration, adding 30% soil restoration additives, desilting water bodies, adding water restoration and purification additives, and establishing air purification dust collectors and desulfurization and denitrification devices; and supervising industrial processing plants in sub-areas, limiting and reducing industrial emissions, demarcating protected areas for endangered plants, carrying out special protection and management, and establishing habitats.

Preferably, the second monitoring points are set up sub-areas that that have received both the first and second qualified marks, so as to so as to collect information and quantity data of harmful plants and establish second invasive alien species datasets; and the invasive species interference indexes Rqgr are constructed based on the second alien invasion datasets, and the invasive species interference indexes Rqgr are generated by following formulas:

$$Rqgr = {\sum }_{i = 1}^{m} ( \frac{{O}_{i} \times {R}_{i}}{{B}_{i} \times {Dist}_{i}} ) ,$$

where Oᵢ represents number of individuals of i-th harmful plant population, Rᵢ represents distribution density of the i-th harmful plant population, m represents number of harmful plant species in the sub-areas, Bᵢ represents area of distribution range of the i-th plant population, and Distᵢ represents distance between the i-th harmful plant population and the endangered plants;
when an invasive species interference index Rqgr exceeds the safety threshold, it means that the invasive species has a threat risk, the second early warning instruction is sent externally; and
when an invasive species interference index Rqgr does not exceed the safety threshold, it means that the invasive species does not have a threat risk, but it is necessary to strengthen the monitoring and control of potential invasive species.

Preferably, a second restoration strategy is generated according to the second early warning instruction, comprising: taking removal measures for discovered invasive species, including manual removal and biological control; establishing isolation zones around areas affected by invasive species, taking isolation measures to prevent spread of invasive species; and strengthening patrol monitoring to prevent illegal destruction and human interference.

### III. Beneficial Effects

The present invention provides a method for monitoring and early warning of wild plant distribution status based on image recognition and has following beneficial effects:
(1) The method for monitoring and early warning of wild plant distribution status based on image recognition utilizes convolutional neural network (CNN) models or deep learning model techniques to establish plant recognition models, analyzes the image dataset to identify species and coverage of endangered plants and calculates distribution and coverage of endangered plants in the sub-areas to obtain coverage indexes Fgl and population complexity indexes fz. The present invention improves the accuracy and efficiency of monitoring, enabling real-time surveillance and management of endangered plants. By calculating the coverage indexes Fgl and the population complexity indexes fz, it is possible to comprehensively assess the ecological conditions of each sub-area and mark them in a three-dimensional ecological model, clearly identifying areas that qualify for protection and diversified population structures. When a coverage index Fgl exceeds the preset protection threshold, it indicates that the sub-area meets the ecological protection criteria; when a population complexity index fz surpasses the second preset ecological stability threshold, it signifies that the diversified population structure in the sub-area is qualified. This marking method can promptly detect environmental pressures and the threats posed by invasive species to the ecosystem, providing scientific basis for developing corresponding maintenance strategies.
(2) The method for monitoring and early warning of wild plant distribution status based on image recognition can scientifically evaluate the ecological protection status of each sub-area by calculating the coverage indexes Fgl and the population complexity indexes fz. Qualified and unqualified marking can be performed in the three-dimensional ecological model to provide a scientific basis for ecological protection and restoration decisions. The calculation and analysis of the coverage indexes Fgl and the population complexity indexes fz help to timely discover changes in the ecological environment. When a coverage index or population complexity index of a sub-area does not reach the preset threshold, it can be quickly marked as unqualified, providing early warning information to ensure the timely implementation of ecological protection measures and prevent further deterioration of the ecological environment. By accurately identifying endangered plants and harmful plants and marking them accordingly, it is helpful to strengthen ecological protection and management. In particular, targeted protection measures can be taken to protect endangered plants to prevent their further reduction or extinction, thereby promoting the stability and healthy development of the ecosystem.
(3) The method for monitoring and early warning of wild plant distribution status based on image recognition can scientifically evaluate the environmental pressure conditions in the sub-area by calculating the environmental pressure indexes HJyl . The environmental pressure indexes HJyl takes into account multiple key environmental factors, such as air temperature, rainfall, light time, distance from industrial processing plants, and pollution pressure indexes, and provides a comprehensive environmental pressure assessment indicator. When an environmental pressure index HJyl is higher than the preset first pressure threshold, the system will automatically send the first early warning instruction, indicating that the environmental pollution condition is unqualified. This timely early warning mechanism helps to take countermeasures quickly to prevent environmental deterioration and ensure the timeliness and effectiveness of ecological protection. The calculation method of the pollution indexes and the environmental pressure indexes can be adjusted according to the environmental characteristics of the specific region and is applicable to different types of ecosystems and environmental conditions.
(4) The method for monitoring and early warning of wild plant distribution status based on image recognition can effectively monitor and evaluate the impact of alien invasive species on the ecosystem by setting up second monitoring points and constructing the invasive species interference indexes Rqgr. Timely sending of the second early warning instruction helps to quickly respond to and control invasive species and protect the stability of local endangered plants and ecosystems. Strengthening the monitoring and control of potential invasive species helps to prevent and mitigate ecological risks that may arise in the future.

### BRIEF DESCRIPTION OF THE DRAWINGS

FIG. 1 is a schematic flow chart of steps of a method for monitoring and early warning of wild plant distribution status based on image recognition according to the present invention.

### SPECIFIC EMBODIMENTS

The following will be combined with the accompanying drawing in embodiments of the present invention to clearly and completely describe the technical solutions in the embodiments of the present invention. Obviously, the described embodiments are only some embodiments of the present invention, rather than all the embodiments. Based on the embodiments of the present invention, all other embodiments obtained by ordinary technicians in this field without creative work are within the scope of protection of the present invention.

### Embodiment 1

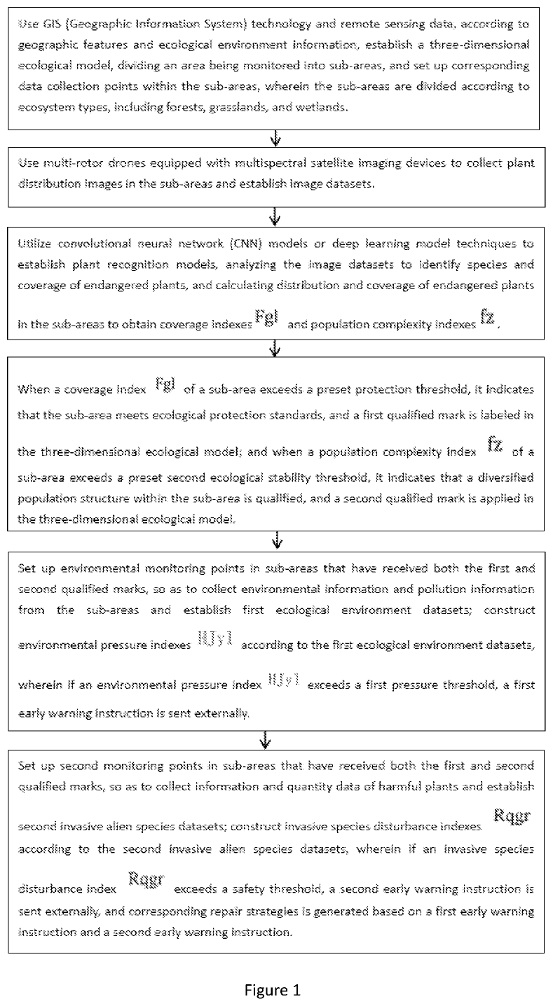

Please refer to FIG. 1, the present invention provides a method for monitoring and early warning of wild plant distribution status based on image recognition, comprising the following steps of:
using GIS (Geographic Information System) technology and remote sensing data, according to geographic features and ecological environment information, establishing a three-dimensional ecological model, dividing an area being monitored into sub-areas, and setting up corresponding data collection points within the sub-areas, wherein the sub-areas are divided according to ecosystem types, including forests, grasslands, and wetlands;
using multi-rotor drones equipped with multispectral satellite imaging devices to collect plant distribution images in the sub-areas, and establishing image datasets;
utilizing convolutional neural network (CNN) models or deep learning model techniques to establish plant recognition models, analyzing the image datasets to identify species and coverage of endangered plants, and calculating distribution and coverage of endangered plants in the sub-areas to obtain coverage indexes Fgl and population complexity indexes fz, wherein
when a coverage index Fgl of a sub-area exceeds a preset protection threshold, it indicates that the sub-area meets ecological protection standards, and a first qualified mark is labeled in the three-dimensional ecological model.
when a population complexity index fz of a sub-area exceeds a preset second ecological stability threshold, it indicates that a diversified population structure within the sub-area is qualified, and a second qualified mark is applied in the three-dimensional ecological model;
setting up environmental monitoring points in sub-areas that have received both the first and second qualified marks, so as to collect environmental information and pollution information from the sub-areas and establish first ecological environment datasets; constructing environmental pressure indexes HJyl according to the first ecological environment datasets, wherein if an environmental pressure index HJyl exceeds a first pressure threshold, a first early warning instruction is sent externally.
setting up second monitoring points in sub-areas that have received both the first and second qualified marks, so as to collect information and quantity data of harmful plants and establish second invasive alien species datasets; constructing invasive species disturbance indexes Rqgr according to the second invasive alien species datasets, wherein if an invasive species disturbance index Rqgr exceeds a safety threshold, a second early warning instruction is sent externally, and corresponding repair strategies is generated based on a first early warning instruction and a second early warning instruction.

In the present embodiment, the distribution and coverage of endangered plants are important indicators for assessing health of ecosystems. Areas with high coverage usually have higher conservation value. Classifying and maintaining these areas can effectively protect the living environment of endangered plants and prevent them from further reduction or extinction. However, the existing technology has great limitations in identifying and analyzing the distribution of endangered plants, and cannot provide accurate coverage data in a timely manner, thereby affecting the implementation effect of protection measures.

The present technical solution proposes a method for monitoring and early warning of wild plant distribution status based on image recognition, which is an efficient and accurate monitoring method, wherein GIS technology and remote sensing data, combined with multi-rotor drones carrying multispectral satellite imaging equipment are used to collected plant distribution images of the sub-areas and established image datasets. Through the convolutional neural network (CNN) models or deep learning model technology, plant recognition models are established to analyze the image datasets, which can efficiently and accurately identify endangered plant species and their coverage, and calculate the distribution and coverage of endangered plants in the sub-areas to obtain the coverage indexes and Fgl population complexity indexes fz. This method improves the accuracy and efficiency of monitoring and realizes real-time monitoring and management of endangered plants. By calculating the coverage indexes Fgl and the population complexity indexes fz, the ecological status of the sub-areas can be comprehensively evaluated and marked in the three-dimensional ecological models to identify the protected areas and areas with qualified diversified population structures. When a coverage index Fgl of a sub-area exceeds the preset protection threshold, it means that the sub-area meets the ecological protection range; when the population complexity index fz of a sub-area exceeds the preset second ecological stability threshold, it means that the diversified population structure in the sub-area is qualified. This marking method can timely detect the threats of environmental pressure and invasive species to the ecosystem, provide scientific basis, and formulate corresponding maintenance strategies.

The technical solution can solve the problems of low monitoring efficiency, low information utilization, and difficulty in achieving real-time monitoring and management in existing technologies, and provide strong technical support for ecological protection. Combined with the analysis of environmental information and pollution data, this solution can construct environmental pressure indexes and invasive species interference indexes. When these indexes exceed the safety threshold, early warning instructions will be issued in time to ensure the health and stability of the ecosystem. Through the application of this system, endangered plants in the wild can be better protected and ecological balance can be maintained.

### Embodiment 2

The present embodiment is explained in embodiment 1. Specifically, the geographical features and ecological environment are obtained by using GIS technology and remote sensing data, high-resolution satellite imagery and drone aerial photography in the area being monitored, which comprise topography, vegetation coverage, and hydrological characteristics; the three-dimensional ecological model is established according to obtained geographic and ecological data of the area being monitored, and the three-dimensional ecological model comprises following components: terrain elevation data DEM, vegetation type layers and hydrological layers; the vegetation type layers show spatial distribution of different vegetation types, and the hydrological layers show location and characteristics of rivers, lakes and wetlands; and
according to the three-dimensional ecological model, the area be monitored is divided into sub-areas, and collection points are established in the sub-areas.

In the present embodiment, the geographical features and ecological environment information of the area to be monitored can be accurately obtained through high-resolution satellite images and drone aerial photography data. By using these high-precision data, a detailed three-dimensional ecological model can be established to make the monitoring of the ecological conditions in the area to be monitored more accurate and comprehensive. The three-dimensional ecological model contains terrain elevation data, vegetation type layers and hydrological layers, which can fully display the geographical and ecological characteristics of the area to be monitored. The integration and display of these data can help ecologists and environmental protection workers to more comprehensively evaluate the health of the ecosystem and discover potential ecological problems. Setting multiple data collection points in each sub-area can efficiently collect various types of environmental data. This systematic data collection method can improve the efficiency of data acquisition and ensure the comprehensiveness and timeliness of data. According to the three-dimensional ecological model, the area to be monitored is divided into several sub-areas, and data collection points are set to make the monitoring of different ecosystems in the area more refined. This division method can carry out targeted monitoring and management for different ecosystem types (such as forests, grasslands, and wetlands).

### Embodiment 3

The present embodiment is explained in embodiment 1. Specifically, the image datasets obtained by drones are spliced into a complete image covering the sub-areas, the plant recognition models are established after performing geometric correction and spectral correction on the image datasets, and image recognition tasks are processed through convolutional neural networks (CNN), endangered plant species, non-endangered plant species, harmful plant species, plant health status, vegetation type characteristics and coverage area characteristics in the sub-areas, are extracted, and the image datasets are labeled to mark out category and location information of each plant; and the image datasets are used as first input into the plant recognition models to calculate the coverage indexes Fgl and the population complexity indexes fz, wherein
the coverage indexes Fgl are generated by following formulas:

$${CR}_{i} = \frac{{A}_{i}}{{A}_{total}} ,$$

$$H = - {\sum }_{i = 1}^{n} ( \frac{{A}_{i}}{{A}_{total}} * ln ( \frac{{A}_{i}}{{A}_{total}} ) ) , and$$

$$Fgl = {\sum }_{i = 1}^{n} ( {w}_{i} * {CR}_{i} ) * H ,$$

where CR represents a population proportion of i-th endangered plant species, Aₜₒₜₐₗ represents a total area of the sub-areas, Aᵢ represents a coverage area of the i-th endangered plant species, Wᵢ represents weight of the i-th endangered plant species, based on degree of endangerment and ecological importance, n represents species number of the endangered plants in the sub-areas, H represents uniformity index of plant coverage, calculated by Shannon index, and ln represents logarithmic operation; and
when a coverage index Fgl of a sub-area exceeds a preset protection threshold, it means that the sub-area meets ecological protection standards and the first qualified mark is labeled in the three-dimensional ecological model; and when a coverage index Fgl of a sub-area does not exceed the preset protection threshold, it means that the coverage of the sub-area is unqualified and a first unqualified mark is labeled.

Specifically, the population complexity indexes fz are generated as follows:

$${P}_{i} = \frac{{N}_{i}}{{\sum }_{i = 1}^{n} {N}_{i}} ,$$

$$M = - {\sum }_{i = 1}^{n} {w}_{i} * {P}_{i}^{1 - q} and$$

$$fz = M * \frac{n}{{N}_{total}} ,$$

where Nₜₒₜₐₗ represents total number of all plant species within the sub-areas, Nᵢ represents number of individuals of the i-th endangered plants species, Wᵢ represents weight of the i-th endangered plant species, based on degree of endangerment and ecological importance; n represents species number of the endangered plants in the sub-areas, Pᵢ represents a relative proportion of the i-th endangered plant species, namely, a ratio of a number of individuals to a total number, q represents an adjustment parameter, ranging from 0 to 2, when q=1, value of M equals to weighted sum of different population proportions, when q≠1, and value of M reflects distribution difference of population proportions; and when a population complexity index fz of a sub-area exceeds a preset second ecological stability threshold, it means that a diversified population structure in the sub-area is qualified, and a second qualified mark is labeled in the three-dimensional ecological model; when a population complexity index fz of a sub-area does not exceed the preset second ecological stability threshold, it means that the diversified population structure in the sub-area is unqualified, and a second unqualified mark is labeled.

In the present embodiment, by using the convolutional neural network CNN models to process the image recognition tasks, endangered plants, non-endangered plants and harmful plant species in the sub-areas can be efficiently and accurately identified. This efficient recognition method reduces manual intervention and improves the efficiency and accuracy of data processing. After geometric correction and spectral correction are performed on the image data obtained by the drone, the accuracy and consistency of the data can be ensured. By extracting the plant species, health status, vegetation type characteristics and coverage area characteristics in the sub-area, comprehensive monitoring of the ecological environment is achieved, which helps to understand and grasp the overall health status of the ecosystem. By calculating the coverage indexes Fgl and the population complexity indexes fz, the ecological protection status of each sub-area can be scientifically evaluated. Qualified and unqualified markings can be made in the three-dimensional ecological model to provide a scientific basis for ecological protection and restoration decisions. The calculation and analysis of the coverage index Fgl and the population complexity index help to timely discover changes in the ecological environment. When the coverage index or population complexity index of a sub-area does not reach the preset threshold, it can be quickly marked as unqualified, providing early warning information, ensuring the timely implementation of ecological protection measures, and preventing further deterioration of the ecological environment. Accurately identifying endangered and harmful plants and marking them accordingly will help strengthen ecological protection and management. In particular, targeted protection measures can be taken to protect endangered plants, prevent their further reduction or extinction, and promote the stability and healthy development of the ecosystem.

When the population complexity index fz exceeds the preset threshold, it means that the diversified population structure in the sub-area is qualified, which helps to maintain the diversity and stability of the ecosystem. The diversified population structure not only improves the ecosystem's ability to resist risks, but also enhances its ability to self-repair and recover.

### Embodiment 4

The present embodiment is explained in embodiment 1. Specifically, the environmental monitoring points are set up in sub-areas that obtain the first qualified marks and the second qualified marks at the same time, so as to collect environmental information and pollution information in the sub-areas and establish first ecological environment datasets; the environmental information includes but is not limited to following data: average daily air temperature wd, average daily rainfall jyl and average daily sunshine time pjgz for 7-15 days obtained meteorological sensors; and longitude and latitude coordinates of industrial processing plants and the sub-areas and distance values jlz between the industrial processing plants near the sub-areas obtained by GPS receivers;
the pollution information includes but is not limited to following data: soil moisture content hs1, soil pH ph1 soil heavy metal and organic matter total content hlz1, water body pH ph2, water body heavy metal and organic matter total content hlz2, atmospheric PM2.5 concentration value pm1, sulfur dioxide concentration value SO₂ in air and nitrogen monoxide concentration value CO in air;
the soil moisture content hs1 is collected and obtained through humidity sensors;
the soil pH ph1 is measured and obtained through soil pH sensors;
the soil heavy metal and organic matter total content hlz1 is obtained through chemical analysis of soil samples;
the water body pH ph2 is measured and obtained through water quality pH sensors;
the water body heavy metal and organic matter total content hlz2 is obtained through chemical analysis of water samples;
the atmospheric PM2.5 concentration value pm1 is measured and obtained through atmospheric particle sensors;
the sulfur dioxide concentration value SO₂ in air and the nitrogen monoxide concentration value CO in air are measured and obtained through air quality sensors.

Specifically, daily average air temperature wd, daily average rainfall jyl, daily average sunshine time pjgz, distance values between industrial processing plants near the sub-areas jlz and pollution pressure indexes wryl are extracted from the first ecological environment datasets and dimensionless processed, and the environmental pressure indexes HJyl are calculated by following formula:

$$HJyl = d 1 * \begin{matrix}wd \\ \overline{\overline{wd}}\end{matrix} + d 2 * \begin{matrix}jyl \\ \overline{\overline{jyl}}\end{matrix} + d 3 * \begin{matrix}pjgz \\ \overline{\overline{pjgz}}\end{matrix} + d 4 * \frac{jlz * wryl}{ln 2} + {A}_{4} ,$$

where w̅d̅ represents a preset air temperature mean threshold, j̅y̅l̅ represents the preset rainfall mean threshold, p̅j̅g̅z̅ represents the preset daily average light exposure time threshold, ln2 represents the logarithmic operation with the natural number 2 as the base, d1, d2, d3 and d4 represent weight values, and 0<d1<1, 0<d2<1, 0<d3<1, 0<d4<1, and d1+d2+d3+r4=1.0; A₄ represents the fourth constant correction coefficient; If an environmental pressure index HJyl is higher than the first pressure threshold, it indicates that environmental pollution is in an unqualified state, and the first early warning instruction is sent externally; and when an environmental pressure index HJyl is less than or equal to the first pressure threshold, it indicates that environmental pressure is qualified.

In the present embodiment, by setting up environmental monitoring points in the sub-areas where the first qualified mark and the second qualified mark are obtained, the environmental information and pollution information in the area being monitored can be fully collected. This monitoring method covers a variety of environmental factors such as meteorological data, soil, and water and air pollution, ensuring comprehensive monitoring of environmental conditions. The method of calculating the soil pollution index, water pollution index and air pollution index after dimensionless processing can effectively integrate a variety of environmental data and provide an intuitive and easy-to-understand pollution status assessment. These indices can be flexibly adjusted according to the specific conditions of different regions through weight adjustment and the application of correction coefficients, thereby improving the accuracy and applicability of data analysis.

By calculating the environmental pressure indexes HJyl, the environmental pressure status in the sub-areas can be scientifically evaluated. The environmental pressure indexes take into account multiple key environmental factors, such as air temperature, rainfall, sunshine time, distance from industrial processing plants and pollution pressure indexes, and provide a comprehensive environmental pressure assessment indicator. When an environmental pressure index HJyl is higher than the preset first pressure threshold, the system will automatically send the first early warning instruction, indicating that the environmental pollution status is unqualified. This timely warning mechanism helps to take countermeasures quickly to prevent environmental deterioration and ensure the timeliness and effectiveness of ecological protection. The calculation method of the pollution indexes and environmental pressure indexes can be adjusted according to the environmental characteristics of the specific area and is applicable to different types of ecosystems and environmental conditions. This method is not only applicable to natural ecosystems such as forests, grasslands, and wetlands, but also to environmental monitoring and management in cities and industrial areas. By calculating and analyzing the pollution index of soil, water and air separately, targeted control measures can be taken for different pollution sources and pollution types. For example, through the use of specific soil remediation, cleaning of water pollutants and air purification devices, different types of environmental pollution can be effectively controlled and reduced.

### Embodiment 5

The present embodiment is explained in embodiment 4. Specifically, according to the first early warning instruction, a first restoration strategy is generated: vegetation restoration, comprising adding 30% soil restoration additives, desilting water bodies, adding water restoration and purification additives, and establishing air purification dust collectors and desulfurization and denitrification devices; and
supervising industrial processing plants in sub-areas, comprising limiting and reducing industrial emissions, demarcating protected areas for endangered plants, carrying out special protection and management, and establishing habitats.

In the present embodiment, the first restoration strategy generated covers comprehensive treatment measures for vegetation, soil, water and air. This multi-level ecological restoration method ensures the comprehensive restoration of the environment and helps to improve the overall ecological environment quality. The vegetation restoration strategy can promote the growth of plants in the sub-area, increase the green coverage area, and improve the ecological stability and biodiversity of the region. This not only helps to prevent soil erosion, but also improves air quality and enhances the beauty of the landscape. Adding 30% soil restoration additives can effectively improve soil structure and fertility, promote the reproduction of soil microorganisms, and improve soil health. The use of restoration additives can quickly and effectively reduce soil heavy metals and organic pollutants, improve soil water holding capacity and plant growth conditions. By desilting the water body and adding water restoration and purification additives, sediments and pollutants in the water body can be effectively removed, and the transparency and water quality of the water body can be improved. Purification additives help reduce harmful substances in the water body, improve the water ecological environment, and promote the healthy growth of aquatic plants and animals. The establishment of air purification and dust removal equipment and desulfurization and denitrification equipment can effectively reduce the concentration of harmful substances such as particulate matter, sulfur dioxide and nitrogen monoxide in the atmosphere, improve air quality and reduce the impact on residents' health. The implementation of air purification measures will help improve the air environment of the sub-area and provide a fresh and healthy living environment.

### Embodiment 6

The present embodiment is explained in embodiment 1. Specifically, the second monitoring points are set up sub-areas that that have received both the first and second qualified marks, so as to so as to collect information and quantity data of harmful plants and establish second invasive alien species datasets; and the invasive species interference indexes Rqgr are constructed based on the second alien invasion datasets, and the invasive species interference indexes Rqgr are generated by following formulas:

$$Rqgr = {\sum }_{i = 1}^{m} ( \frac{{O}_{i} \times {R}_{i}}{{B}_{i} \times {Dist}_{i}} ) ,$$

where Oᵢ represents number of individuals of i-th harmful plant population, Rᵢ represents distribution density of the i-th harmful plant population, m represents number of harmful plant species in the sub-areas, Bᵢ represents area of distribution range of the i-th plant population, and Distᵢ represents distance between the i-th harmful plant population and the endangered plants;
when an invasive species interference index Rqgr exceeds the safety threshold, it means that the invasive species has a threat risk, the second early warning instruction is sent externally; and
when an invasive species interference index Rqgr does not exceed the safety threshold, it means that the invasive species does not have a threat risk, but it is necessary to strengthen the monitoring and control of potential invasive species.

In the present embodiment, by setting up the second monitoring points and constructing the invasive species interference indexes Rqgr, the impact of alien invasive species on the ecosystem can be effectively monitored and evaluated. Timely sending of the second early warning instruction helps to quickly respond to and control invasive species and protect the stability of local endangered plants and ecosystems. Strengthening the monitoring and control of potential invasive species helps prevent and mitigate ecological risks that may arise in the future.

### Embodiment 7

The present embodiment is explained in embodiment 6. Specifically, a second restoration strategy is generated according to the second early warning instruction, comprising: taking removal measures for discovered invasive species, including manual removal and biological control; establishing isolation zones around areas affected by invasive species, taking isolation measures to prevent spread of invasive species; and strengthening patrol monitoring to prevent illegal destruction and human interference.

In the present embodiment, human forces are organized to physically remove, cut or burn the invasive species to ensure that their roots and propagation materials are completely removed. Natural enemies or competitive species of invasive species are introduced to use natural ecological relationships to inhibit the spread and growth of invasive species. Appropriate biological agents, such as pathogens or insects, are used to biologically control invasive species. Isolation zones are established around areas affected by invasive species to prevent the spread of invasive species through physical barriers, chemical barriers or plant isolation zones. Isolation zones can include protective nets, fences or planting of local plants to form a natural protective barrier. Increase the frequency and intensity of patrols to ensure timely discovery and treatment of newly emerging invasive species. Technical means such as drones and monitoring equipment are used to comprehensively monitor the dynamics of invasive species to ensure that there are no blind spots in monitoring. Law enforcement in the region is strengthened to prevent illegal logging, grazing and other behaviors from causing damage to the ecosystem. Through publicity and education, raise public awareness of the harm of invasive species and encourage communities to participate in the monitoring and prevention of invasive species.

Containment of spread: directly reduce the number of invasive species through artificial removal and biological control, and curb their further spread and reproduction.

Ecological protection: establish isolation zones and strengthen patrol monitoring to effectively protect local endangered plants and ecosystems and prevent invasive species from causing long-term damage to local ecosystems.

Improve response capabilities: by strengthening monitoring and preventing human interference, we can improve early warning and response capabilities to invasive species and ensure timely measures to reduce ecological risks.

Although embodiments of the present invention have been shown and described, it will be appreciated by those skilled in the art that various changes, modifications, substitutions and variations may be made to the embodiments without departing from the principles and spirit of the present invention, and the scope of the present invention is defined by the appended claims and their equivalents.

1. A method for monitoring and early warning of wild plant distribution status based on image recognition, comprising following steps of:
using GIS (Geographic Information System) technology and remote sensing data, according to geographic features and ecological environment information, establishing a three-dimensional ecological model, dividing an area being monitored into sub-areas, and setting up corresponding data collection points within the sub-areas, wherein the sub-areas are divided according to ecosystem types, including forests, grasslands, and wetlands;
using multi-rotor drones equipped with multispectral satellite imaging devices to collect plant distribution images in the sub-areas, and establishing image datasets;
utilizing convolutional neural network (CNN) models or deep learning model techniques to establish plant recognition models, analyzing the image datasets to identify species and coverage of endangered plants, and calculating distribution and coverage of endangered plants in the sub-areas to obtain coverage indexes Fgl and population complexity indexes fz, wherein
when a coverage index Fgl of a sub-area exceeds a preset protection threshold, it indicates that the sub-area meets ecological protection standards, and a first qualified mark is labeled in the three-dimensional ecological model; and when a population complexity index fz of a sub-area exceeds a preset second ecological stability threshold, it indicates that a diversified population structure within the sub-area is qualified, and a second qualified mark is applied in the three-dimensional ecological model;
setting up environmental monitoring points in sub-areas that have received both the first and second qualified marks, so as to collect environmental information and pollution information from the sub-areas and establish first ecological environment datasets; constructing environmental pressure indexes HJyl according to the first ecological environment datasets, wherein if an environmental pressure index HJyl exceeds a first pressure threshold, a first early warning instruction is sent externally; and
setting up second monitoring points in sub-areas that have received both the first and second qualified marks, so as to collect information and quantity data of harmful plants and establish second invasive alien species datasets; constructing invasive species disturbance indexes Rqgr according to the second invasive alien species datasets, wherein if an invasive species disturbance index Rqgr exceeds a safety threshold, a second early warning instruction is sent externally, and corresponding repair strategies is generated based on a first early warning instruction and a second early warning instruction.

2. The method for monitoring and early warning of wild plant distribution status based on image recognition according to claim 1, wherein the geographical features and ecological environment are obtained by using GIS technology and remote sensing data, high-resolution satellite imagery and drone aerial photography in the area being monitored, which comprise topography, vegetation coverage, and hydrological characteristics; the three-dimensional ecological model is established according to obtained geographic and ecological data of the area being monitored, and the three-dimensional ecological model comprises following components: terrain elevation data DEM, vegetation type layers and hydrological layers; the vegetation type layers show spatial distribution of different vegetation types, and the hydrological layers show location and characteristics of rivers, lakes and wetlands; and
according to the three-dimensional ecological model, the area be monitored is divided into sub-areas, and collection points are established in the sub-areas.

3. The method for monitoring and early warning of wild plant distribution status based on image recognition according to claim 1, wherein the image datasets obtained by drones are spliced into a complete image covering the sub-areas, the plant recognition models are established after performing geometric correction and spectral correction on the image datasets, and image recognition tasks are processed through convolutional neural networks (CNN), endangered plant species, non-endangered plant species, harmful plant species, plant health status, vegetation type characteristics and coverage area characteristics in the sub-areas, are extracted, and the image datasets are labeled to mark out category and location information of each plant; and the image datasets are used as first input into the plant recognition models to calculate the coverage indexes Fgl and the population complexity indexes fz, wherein
the coverage indexes Fgl are generated by following formulas:
$${CR}_{i} = \frac{{A}_{i}}{{A}_{total}} ,$$
$$H = - {\sum }_{i = 1}^{n} ( \frac{{A}_{i}}{{A}_{total}} * ln ( \frac{{A}_{i}}{{A}_{total}} ) ) , and$$
$$Fgl = {\sum }_{i = 1}^{n} ( {w}_{i} * {CR}_{i} ) * H ,$$
where CRᵢ represents a population proportion of i-th endangered plant species, Aₜₒₜₐₗ represents a total area of the sub-areas, Aᵢ represents a coverage area of the i-th endangered plant species, Wᵢ represents weight of the i-th endangered plant species, based on degree of endangerment and ecological importance, n represents species number of the endangered plants in the sub-areas, H represents uniformity index of plant coverage, calculated by Shannon index, and ln represents logarithmic operation; and
when a coverage index Fgl of a sub-area exceeds a preset protection threshold, it means that the sub-area meets ecological protection standards and the first qualified mark is labeled in the three-dimensional ecological model; and when a coverage index Fgl of a sub-area does not exceed the preset protection threshold, it means that the coverage of the sub-area is unqualified and a first unqualified mark is labeled.

4. The method for monitoring and early warning of wild plant distribution status based on image recognition according to claim 3, wherein the population complexity indexes fz are generated as follows:
$${P}_{i} = \frac{{N}_{i}}{{\sum }_{i = 1}^{n} {N}_{i}} ,$$
$$M = - {\sum }_{i = 1}^{n} {w}_{i} * {P}_{i}^{1 - q} and$$
$$fz = M * \frac{n}{{N}_{total}} ,$$
where Nₜₒₜₐₗ represents total number of all plant species within the sub-areas, Nᵢ represents number of individuals of the i-th endangered plants species, Wᵢ represents weight of the i-th endangered plant species, based on degree of endangerment and ecological importance; n represents species number of the endangered plants in the sub-areas, Pᵢ represents a relative proportion of the i-th endangered plant species, namely, a ratio of a number of individuals to a total number, q represents an adjustment parameter, ranging from 0 to 2, when q=1, value of M equals to weighted sum of different population proportions, when q≠1, and value of M reflects distribution difference of population proportions; and
when a population complexity index fz of a sub-area exceeds a preset second ecological stability threshold, it means that a diversified population structure in the sub-area is qualified, and a second qualified mark is labeled in the three-dimensional ecological model; when a population complexity index fz of a sub-area does not exceed the preset second ecological stability threshold, it means that the diversified population structure in the sub-area is unqualified, and a second unqualified mark is labeled.

5. The method for monitoring and early warning of wild plant distribution status based on image recognition according to claim 1, wherein the environmental monitoring points are set up in sub-areas that obtain the first qualified marks and the second qualified marks at the same time, so as to collect environmental information and pollution information in the sub-areas and establish first ecological environment datasets; the environmental information includes but is not limited to following data: average daily air temperature wd, average daily rainfall jyl and average daily sunshine time pjgz for 7-15 days obtained meteorological sensors; and longitude and latitude coordinates of industrial processing plants and the sub-areas and distance values jlz between the industrial processing plants near the sub-areas obtained by GPS receivers;
the pollution information includes but is not limited to following data: soil moisture content hs1, soil pH ph1 soil heavy metal and organic matter total content hlz1, water body pH ph2, water body heavy metal and organic matter total content hlz2, atmospheric PM2.5 concentration value pm1, sulfur dioxide concentration value SO₂ in air and nitrogen monoxide concentration value CO in air;
the soil moisture content hs1 is collected and obtained through humidity sensors;
the soil pH ph1 is measured and obtained through soil pH sensors;
the soil heavy metal and organic matter total content hlz1 is obtained through chemical analysis of soil samples;
the water body pH ph2 is measured and obtained through water quality pH sensors;
the water body heavy metal and organic matter total content hlz2 is obtained through chemical analysis of water samples;
the atmospheric PM2.5 concentration value pm1 is measured and obtained through atmospheric particle sensors; and
the sulfur dioxide concentration value SO₂ in air and the nitrogen monoxide concentration value CO in air are measured and obtained through air quality sensors.

6. The method for monitoring and early warning of wild plant distribution status based on image recognition according to claim 5, wherein dimensionless processing is conducted on the pollution information, and soil pollution indexes trwr, water pollution indexes swr and air pollution indexes kqwr are obtained by as following formulas:
$$trwr = \sqrt{w 1 * {( \begin{matrix}hs l \\ \overline{\overline{hsl}}\end{matrix} )}^{2} + w 2 * {( \begin{matrix}p h 1 \\ \overline{\overline{p h 1}}\end{matrix} )}^{2} + w 3 * {( \begin{matrix}hlz 1 \\ \overline{\overline{hlz 1}}\end{matrix} )}^{2} + {A}_{1}} ,$$
$$swr = \sqrt{w 4 * {( \begin{matrix}hlz 2 \\ \overline{\overline{hlz 2}}\end{matrix} )}^{2} + w 5 * {( \begin{matrix}p h 2 \\ \overline{\overline{p h 2}}\end{matrix} )}^{2} + {A}_{2}} , and$$
$$kqwr = \sqrt{w 6 * {( \begin{matrix}pm 1 \\ \overline{\overline{pm 1}}\end{matrix} )}^{2} + w 7 * {( \begin{matrix}{SO}_{2} \\ \overline{\overline{{SO}_{2}}}\end{matrix} )}^{2} + w 8 * {( \begin{matrix}CO \\ \overline{\overline{CO}}\end{matrix} )}^{2} + {A}_{3}} ,$$
where h̅s̅1̅ represents a preset threshold of the soil moisture content, p̅h̅1̅ represents a preset threshold of the soil pH, h̅l̅z̅1̅: represents a preset maximum tolerance threshold of the soil heavy metal and total organic matter content, h̅l̅z̅2̅ represents a preset maximum tolerance threshold of the water body heavy metal and total organic matter content, p̅h̅2̅ represents a preset threshold of the water body pH, p̅m̅1̅ represents a preset threshold of the atmospheric pm2.5 concentration, S̅O̅₂̅ represents a preset maximum tolerance threshold of the sulfur dioxide concentration in air, C̅O̅: represents a preset maximum tolerance threshold of the nitric oxide concentration in air, w1, w2, w3, w4, w5, w6, w7 and w8 represent weight values, and specific values thereof are adjusted and set by users, and 0<w1<1, 0<w2<1, 0<w3<1, 0<w4<1, 0<w5<1, 0<w6<1, 0<w7<1, 0<w8<1, w1+w2+w3=1, w4+w5=1,w6+w7+w8=1, A₁ represents a first constant correction coefficient, A₂ represents a second constant correction coefficient, and A₃ represents a third constant correction coefficient; and
then the soil pollution indexes trwr, the water pollution indexes swr and the air pollution indexes kqwr are combined to generate the pollution pressure indexes wryl through following correlation formula:
$$wry l = γ * trwr + δ * swr + α * kqwr ,$$
where, 0≤γ≤1, 0≤δ≤1, and γ+δ+α=1, γ, δ and α are weight values of the soil pollution indexes trwr, water pollution indexes swr and the air pollution indexes kqwr, which are adjusted and set by users.

7. The method for monitoring and early warning of wild plant distribution status based on image recognition according to claim 1, wherein daily average air temperature wd, daily average rainfall jyl, daily average sunshine time pjgz distance values between industrial processing plants near the sub-areas jlz, and pollution pressure indexes wryl are extracted from the first ecological environment datasets and dimensionless processed, and the environmental pressure indexes HJyl are calculated by following formula:
$$HJyl = d 1 * \begin{matrix}wd \\ \overline{\overline{wd}}\end{matrix} + d 2 * \begin{matrix}jyl \\ \overline{\overline{jyl}}\end{matrix} + d 3 * \begin{matrix}pjgz \\ \overline{\overline{pjgz}}\end{matrix} + d 4 * \frac{jlz * wryl}{ln 2} + {A}_{4} ,$$
where w̅d̅ represents a preset air temperature mean threshold, j̅y̅l̅ represents the preset rainfall mean threshold, p̅j̅g̅z̅ represents the preset daily average light exposure time threshold, ln12 represents the logarithmic operation with the natural number 2 as the base, d1, d2, d3 and d4 represent weight values, and 0<d1<1, 0<d2<1, 0<d3<1, 0<d4<1, and d1+d2+d3+r4=1.0; A₄ represents the fourth constant correction coefficient; If an environmental pressure index HJyl is higher than the first pressure threshold, it indicates that environmental pollution is in an unqualified state, and the first early warning instruction is sent externally; and
when an environmental pressure index HJyl is less than or equal to the first pressure threshold, it indicates that environmental pressure is qualified.

8. The method for monitoring and early warning of wild plant distribution status based on image recognition according to claim 7, wherein according to the first early warning instruction, a first restoration strategy is generated, comprising vegetation restoration, adding 30% soil restoration additives, desilting water bodies, adding water restoration and purification additives, and establishing air purification dust collectors and desulfurization and denitrification devices;
supervising industrial processing plants in sub-areas, comprises limiting and reducing industrial emissions,
demarcating protected areas for endangered plants, carrying out special protection and management, and establishing habitats.

9. The method for monitoring and early warning of wild plant distribution status based on image recognition according to claim 1, wherein the second monitoring points are set up sub-areas that that have received both the first and second qualified marks, so as to so as to collect information and quantity data of harmful plants and establish second invasive alien species datasets; and the invasive species interference indexes Rqgr are constructed based on the second alien invasion datasets, and the invasive species interference indexes Rqgr are generated by following formulas:
$$Rqgr = {\sum }_{i = 1}^{m} ( \frac{{O}_{i} \times {R}_{i}}{{B}_{i} \times {Dist}_{i}} ) ,$$
where Oᵢ represents number of individuals of i-th harmful plant population, Rᵢ represents distribution density of the i-th harmful plant population, m represents number of harmful plant species in the sub-areas, Bᵢ represents area of distribution range of the i-th plant population, and Distᵢ represents distance between the i-th harmful plant population and the endangered plants;
when an invasive species interference index Rqgr exceeds the safety threshold, it means that the invasive species has a threat risk, the second early warning instruction is sent externally; and
when an invasive species interference index Rqgr does not exceed the safety threshold, it means that the invasive species does not have a threat risk, but it is necessary to strengthen the monitoring and control of potential invasive species.

10. The method for monitoring and early warning of wild plant distribution status based on image recognition according to claim 9, wherein a second restoration strategy is generated according to the second early warning instruction, comprising: taking removal measures for discovered invasive species, including manual removal and biological control; establishing isolation zones around areas affected by invasive species, taking isolation measures to prevent spread of invasive species; and strengthening patrol monitoring to prevent illegal destruction and human interference.
